(19) United States
(12) Patent Application Publication
(10) Pub. No.: US 2010/0248980 A1
(43) Pub. Date: Sep. 30, 2010

(54) Method for Selective Labeling and Detection of Target Nucleic Acids Using Immobilized Peptide Nucleic Acid Probes

(75) Inventors: Hee Kyung Park, Daejeon (KR); Jae Jin Choi, Daejeon (KR)

Correspondence Address: THE WEBB LAW FIRM, P.C., 700 KOPPERS BUILDING, 436 SEVENTH AVENUE, PITTSBURGH, PA, 15219, US

(73) Assignee: PANAGENE INC., Daejeon (KR)

(21) Appl. No.: 12/745,857

(22) PCT Filed: Dec. 4, 2008
(86) PCT No.: PCT/KR08/07148

§ 371 Date: Jun. 2, 2010

(30) Foreign Application Priority Data
Dec. 4, 2007 (KR) 10-2007-0125039
Nov. 28, 2008 (KR) 10-2008-0120122

(51) Int. Cl. C40B 30/04; C40B 50/18; C40B 70/00

(52) U.S. Cl. 506/9; 506/32; 506/41

(57) ABSTRACT

Disclosed are a method for selective labeling of target nucleic acids on an array having nucleic acid analogue, e.g. PNA (peptide nucleic acid), probes immobilized on a support or supports, comprising adding to the array a detectable label and an agent for introducing the label into the target nucleic acids, after hybridization between the target nucleic acids and the nucleic acid analogue probes, and a method for detection of target nucleic acids using the same.

### TECHNICAL FIELD

The present invention relates to a method for selective labeling and detection of target nucleic acids using nucleic acid analogue probes immobilized on a support or supports.

More specifically, it relates to a method for selective labeling of target nucleic acids, comprising adding a detectable label and an agent for introducing the label into the target nucleic acids, after hybridization reaction of target nucleic acids, and to a method for detection of target nucleic acids using the same.

### BACKGROUND ART

It is difficult to detect nucleic acids in a state of nature. Thus, they are labeled for detection in various fields of molecular biology or cell biology. Labeled nucleic acids have been widely used for the detection of signals from Southern blotting, Northern blotting, in situ hybridization and nucleic acid microarrays, based on specific hybridization reaction. A method is known to label DNA simultaneously with amplification, by using labeled monomers (labeled dNTPs) or labeled primers in polymerase chain reaction (PCR), and the labeled DNA can be detected from a microarray. The simultaneous labeling of nucleic acids with PCR has an advantage to require no separate step for labeling. However, it has a drawback to have a decreased PCR efficiency by using monomers labeled with fluorophores, etc. Further, RNA cannot be amplified through PCR, and so the synthesis of cDNA through reverse transcription should be preceded for detecting RNA by labeling in PCR. However, particularly, in case of short RNA, such as microRNA (miRNA), synthesis of cDNA is very cumbersome.

In case of using probes immobilized on a microarray or a chip, as the length of target nucleic acids is increased, their approach to the probes is more difficult, and so hybridization efficiency is decreased. So, it is preferable to apply target nucleic acids as short as possible for hybridization. If the length of target nucleic acids is longer than 200 bp, hybridization efficiency will be decreased significantly, so specific signals are decreased and are hardly distinguishable from background signals. If the length of target nucleic acids is longer than 400 bp, specific signals cannot be nearly obtained, and analysis itself will be impossible (Martin et al. (2005) “Optimization of fragmentation conditions for microarray analysis of viral RNA”, Analytical biochemistry, 347, 316-323; and Regis et al. (2005) “Correlation between microarray DNA hybridization efficiency and the position of short capture probe on the target nucleic acid”, BioTechniques, 39, 89-96). To overcome the above problems, attempts have been made to amplify scattered target nucleic acids separately in short fragments, to fragment a long amplification product with restriction enzymes, and to amplify genome followed by re-amplifying it into smaller fragments with each specific primer (Toward genome-wide SNP genotyping, Ann-Christine Syvanen, 2005, Nature genetics, 37, S5-S10; and Assessing Genetic Variation: Genotyping Single Nucleotide Polymorphism, Ann-Christine Syvanen, Nature, 2001, 2, 930-942). However, according to the above methods, all the fragments should be amplified, respectively, which makes the methods cumbersome, and a large amount of fluorophore is needed for amplification with fluorophore-labeled dNTPs or primers. Therefore, those methods are complicated and inefficient, time- and cost-consuming, and/or labor-intensive.

To make the amplification simpler and to increase its efficiency, US Patent Publication Nos. 2004-67493 and 2005-191682 disclose that rather than to label nucleic acids with fluorescent dyes during amplification, upon completion of the amplification, the amplified target nucleic acids are fragmented with nucleases (DNaseI), etc., fluorophores are then attached to double- or single-stranded fragments with terminal deoxynucleotidyl transferase (TdT) or ligase, and finally, hybridization reaction is performed. According to this method, labeling reaction is performed in a solution, after amplifying target nucleic acids and before performing hybridization reaction on a chip or a microarray. In this method, residual dNTPs or amplification enzymes that might interrupt the labeling reaction must be removed. Further, all the fragmented target nucleic acids are labeled with a fluorescent dye, requiring a large amount of enzyme and fluorescent dye to raise production costs (Amplichip CYP 450 test, Roche).

Moreover, non-specific signals might be increased from the reaction of residual target nucleic acids.

Recently, many short non-coding RNAs of 21-35 nucleotides, transcribed from DNA but not translated into protein, have been found. Among them, microRNA is a short single-stranded RNA found in eukaryotes, which is involved in the regulation of gene expression. MicroRNA draws great attention since it has been revealed to play an important role in cancers, cell proliferation, cell differentiation, apoptosis and regulation of lipid metabolism. MicroRNA can also be used as a biomarker, that is, analyzed for its expression pattern to diagnose or prognose cancers or other diseases (Stenvang J, Silahtaroglu AN, Lindow M, Elmen J, Kauppinen S. (2008) “The utility of LNA in microRNA-based cancer diagnostics and therapeutics” Seminars in cancer biology 18:89-102).

Northern blotting, a traditional method for detecting RNA, requires a large amount of RNA, is time-consuming and labor-intensive, and enables detection of only one kind of RNA at a time. To overcome such problems, a method for simultaneous analysis of expression patterns of various microRNAs using a microarray having multiple complementary probes immobilized thereon has been developed. To efficiently analyze expression pattern of microRNAs on a microarray, a method to efficiently label short microRNAs would be essential. In detecting microRNAs without amplification, it would be advantageous to detect them directly without reverse transcription into cDNAs.

It is known to label microRNAs by attaching a label thereto with an enzyme or by chemical reaction. In case of using an enzyme for labeling, a labeled monomer or a nucleotide sequence that can be labeled is attached to the 3′ terminal of microRNA using an enzyme such as ligase, poly(A) polymerase or terminal deoxynucleotidyl transferase.

Alternatively, a label can be attached to its 5′ terminal using polynucleotide kinase. Labeling with phosphate-cytidyl-phosphate (pCp) and T4 ligase has been commercialized (US Patent Publication No. 2008/0026382 A1 “Enzymatic labeling of RNA”; Wang H, Ach R A, Curry B. (2007) “Direct and sensitive miRNA profiling from low-input total RNA” RNA 13:151-159). According to this method, RNA is labeled in a solution with Cy3- or Cy5-linked pCp, followed by analysis on a microarray.

In addition to the enzymatic methods, chemical methods are known for labeling target nucleic acids. For labeling via covalent bonds to nucleobases, the nucleobases are modified, resulting in interrupted hybridization against complementary nucleotide sequences (J. A. Wolff, P. M. Slattum, J. E. Hagstrom, V. G. Budker “Gene expression with covalently modified polynucleotides” U.S. Pat. No. 7,049,142). A chemical labeling method to attach a label to guanine of nucleic acids has the same problems, and further, it cannot be applied for nucleic acid sequences containing no guanine (H. J. Houthoff, J. Reedijk, T. Jelsma, R. J. Heetebrij, H. H. Volkers, “Methods for labeling nucleotides, labeled nucleotides and useful intermediates” U.S. Pat. No. 7,217,813).

Peptide nucleic acid (PNA) is one of nucleic acid analogues in which nucleobases are linked via a peptide bond, not a phosphate bond. It was first synthesized by Nielsen et al. in 1991 (Nielsen P E, Egholm M, Berg R H, Buchardt O. (1991) “Sequence-selective recognition of DNA by strand displacement with a thymine-substituted polyamide”, Science 254:1497-1500). As shown in FIG. 1, phosphodiester bond of DNA is replaced by peptide bond in PNA. Like DNA, PNA has adenine, thymine, guanine and cytosine, so that it can perform base-specific hybridization with DNA or RNA. PNA is not found in nature but artificially synthesized through a chemical process. PNA forms double strand by hybridization with natural nucleic acids having complementary nucleotide sequence.

PNA/DNA double strand is more stable than DNA/DNA double strand and PNA/RNA double strand is more stable than DNA/RNA double strand, as long as they have the same length. PNA has more unstable double stands from a single base mismatch, and thus, is much more effective for detection of SNP (single nucleotide polymorphism), than natural nucleic acids. PNA is not only chemically but also biologically stable because it is not degraded by nucleases or proteases. PNA is electrically neutral, and so stability of PNA/DNA duplex and PNA/RNA duplex is not affected by the concentration of salt.

Recently, studies are ongoing using the stability of PNA against biological enzymes on a chip. For example, the present inventors have contemplated a method for increasing hybridization efficiency between PNA probes and target nucleic acids, comprising adding nucleases during hybridization reaction to fragment the target nucleic acids, and for increasing hybridization specificity, comprising adding nucleases after hybridization reaction to selectively degrade mismatched target nucleic acids, and a patent application was filed and assigned Application No. 2007-18384 therefor in the Republic of Korea.

### DISCLOSURE

### Technical Problem

To overcome the above problems of the prior arts, the present inventors have found that by making PNA unlabeled and only target nucleic acids labeled, more various target nucleic acids can be used, mutations can be detected from a target region with a higher specificity and S/N (signal-to-noise) ratio, without complicated amplification or pretreatment step, and the target nucleic acids can be detected with a higher sensitivity without removing residual unreacted materials, as compared with the prior arts, and completed the present invention.

Thus, it is an object of the present invention to provide a method for efficient labeling of target nucleic acids with immobilized nucleic acid analogue probes.

It is another object of the present invention to provide a method for efficient detection of target nucleic acids with immobilized nucleic acid analogue probes, by using the labeling method.

It is still another object of the present invention to provide a kit for use in the above method for labeling or detection.

### Technical Solution

One aspect of the present invention relates to a method for selective labeling of target nucleic acids on an array having nucleic acid analogue probes immobilized on a support or supports, comprising:

adding to the array a detectable label and an agent for introducing the label into unlabeled target nucleic acids, after hybridization reaction between the nucleic acid analogue probes and the unlabeled target nucleic acids, wherein the nucleic acid analogue probes are not reactive with the agent, so that only the target nucleic acids are selectively labeled.

Another aspect of the present invention relates to a method for detection of target nucleic acids on an array having nucleic acid analogue probes immobilized on a support or supports, comprising:

1) selectively labeling the target nucleic acids according to the above described method; and

2) detecting signals from the label of step 1).

Still another aspect of the present invention relates to a kit for use in the method for selective labeling or detection of target nucleic acids on an array having nucleic acid analogue probes immobilized on a support or supports, comprising:

1) a detectable label enabling the detection of target nucleic acids hybridized with the nucleic acid analogue probes; and

2) an agent for introducing the detectable label not into the nucleic acid analogue probes but into the target nucleic acids hybridized with the nucleic acid analogue probes.

### DESCRIPTION OF DRAWINGS

The above and other objects, features and advantages of the present invention will become apparent from the following description of preferred embodiments given in conjunction with the accompanying drawings, in which:

FIG. 1 shows the difference of basic structure between DNA and PNA;

FIG. 2 schematically compares the principles of the conventional labeling method on a DNA chip according to the prior art and the labeling method on a PNA chip according to one embodiment of the present invention;

FIG. 3 schematically shows the principle of one embodiment of the present invention, comprising fragmenting target nucleic acids during hybridization reaction on a PNA chip, and then, adding a detectable label thereto to selectively label target nucleic acids hybridized with PNA probes;

FIG. 4 schematically shows the post-hybridization labeling on a PNA chip according to one embodiment of the present invention;

FIG. 5 is a photograph showing the results of electrophoresis on 1.5% agarose gel after amplification and nuclease treatment for various sizes of target nucleic acids;

FIGS. 6 to 9 are photographs and graphs showing the fluorescence images and quantitative analysis data for the labeling, after fragmentation followed by hybridization, according to one embodiment of the present invention;

FIG. 10 is a set of graphs showing the quantitative analysis data for the labeling, after fragmentation during hybridization, according to one embodiment of the present invention;

FIG. 11 is a set of graphs showing the quantitative analysis data for the prior art (pre-hybridization labeling) and the present invention (post-hybridization labeling);

FIG. 12 is a photograph showing the fluorescence image from the labeling after hybridization of microRNA on a PNA chip according to one embodiment of the present invention;

FIG. 13 is a photograph showing the fluorescence image from the labeling before hybridization of microRNA on a PNA chip according to the prior art;

FIG. 14 is a graph comparing the fluorescence intensities from the post- and pre-hybridization labelings of microRNA on a PNA chip; and

FIG. 15 is a photograph showing the fluorescence image from the treatment with T4 RNA ligase and pCp-Cy3 on a DNA chip without target nucleic acids hybridized.

### BEST MODE

Hereinafter, the present invention will be described in detail.

PNA is a representative nucleic acid analogue not reactive with the enzymes used for this invention. Therefore, this invention will be described hereunder with reference to a PNA chip or microarray having PNA probes immobilized in a defined position on a support or supports. The method of the present invention can be applied to any devices having PNA probes immobilized on a support or supports, including bead array comprising distinguishable beads with each different PNA probes immobilized thereon.

In this invention, target nucleic acids may or may not be fragmented depending upon their length. Below, embodiments with and without the fragmentation of target nucleic acids will be described, respectively.

1) Embodiments with the Fragmentation of Target Nucleic Acids

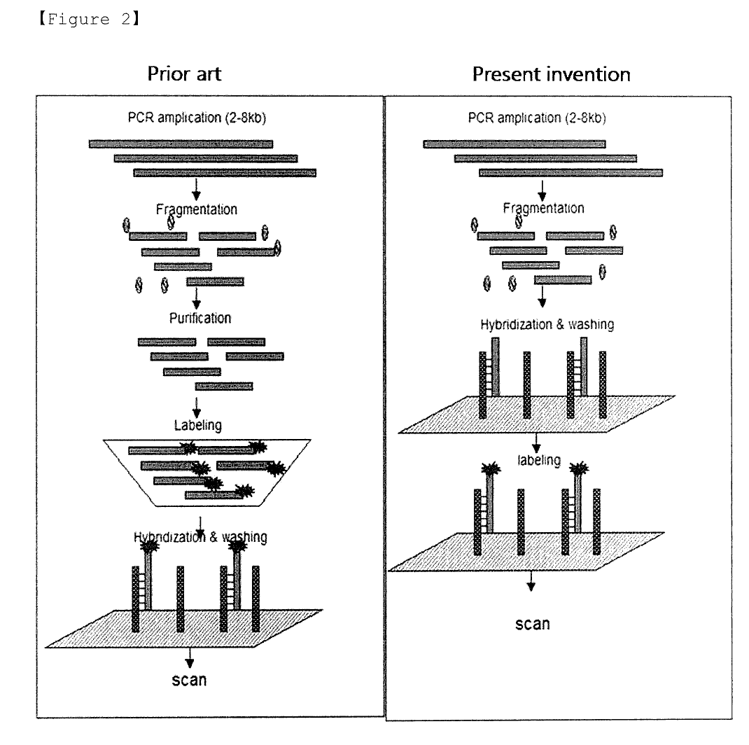

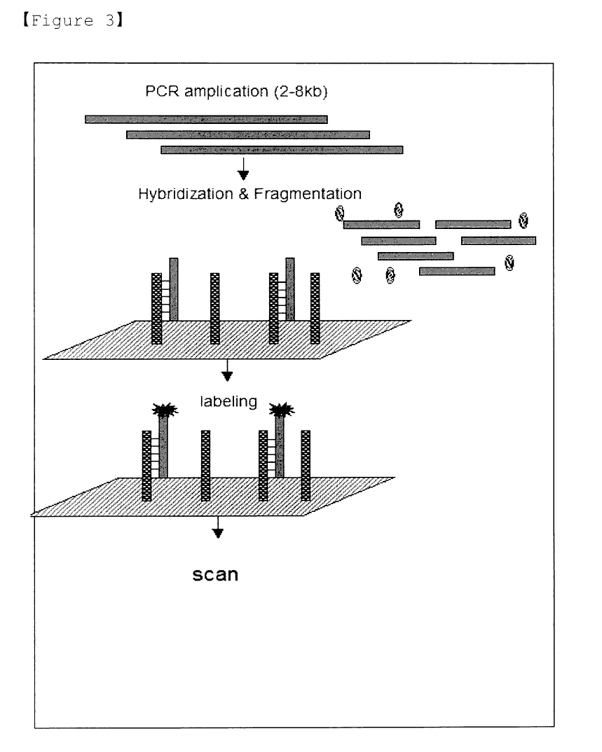

As shown in FIG. 2, in case of long target nucleic acids, for example, of 50 bp-8 kb, particularly, of 2-8 kb, on a conventional DNA chip, the target nucleic acids are amplified and fragmented, the fragments are labeled, and then, hybridized with DNA probes to detect signals therefrom. In comparison, according to one embodiment of the present invention, target nucleic acids are amplified, fragmented followed by hybridization with PNA probes on a PNA chip, and finally, only the hybridized target nucleic acids are selectively labeled. In another embodiment of the present invention, target nucleic acids are amplified, fragmented simultaneously with hybridization on a PNA chip, and then, the target nucleic acids hybridized with PNA probes are selectively labeled (see FIG. 3).

In one embodiment of the present invention, a PNA chip is constructed using PNA oligomers represented by SEQ. ID Nos. 1 to 8, and after hybridization, terminal deoxynucleotidyl transferase and a fluorescent dye are added thereto to detect signals therefrom. According to the method disclosed in Korean Patent No. 464,261, PNA oligomers are synthesized by solid phase synthesis from PNA monomers protected with Bts (benzothiazolesulfonyl) group and a functionalized resin. In addition to this method, PNA can be synthesized according to known Fmoc or Boc method. PNA oligomer of SEQ. ID No. 1 is the probe perfectly matching with 636 position of Exon 4 of CYP 2C19 gene, involved in metabolism of antidepressants and anti-hypersensitivity agents, one of CYP 450 genes, involved in drug metabolism. The PNA oligomer of SEQ. ID No. 2 is designed to have one different nucleotide from that of SEQ. ID No. 1.

The oligomers of SEQ. ID Nos. 3 to 8 are the probes for detecting some SNPs affecting drug metabolism in 2D6 gene, involved in metabolism of various drugs, among CYP450 genes.

The probes correspond to ones perfectly matching with each variant region and ones for detecting variants designed to have one different nucleotide therefrom. The probes are designed and synthesized to have the length of 13 to 17mer.

TABLE 1

| SEQ. | | | |
|---|---|---|---|
| ID No. | Designation | Sequence (5′-3′) | Description |
| 1 | CYP450 2C19- | accccctggatctag | CYP 2C19 636 wild-type |
| | 636w | | sense 15 mer |
| 2 | CYP450 2C19- | cccctgaatccag | CYP 2C19 636 SNP sense |
| | 636m | | 13 mer |
| 3 | CYP450 2D6-F- | tagagaccgggttct | CYP 2D6 promoter region- |
| | 1584w | | 1584 |
| | | | wild-type 15 mer antisense |
| 4 | CYP450 2D6-F- | tagagacccggttct | CYP 2D6 promoter region- |
| | 1584m | | 1584 |
| | | | SNP 15 mer antisense |
| 5 | CYP450 2D6- | cctggccgtgatagt | CYP 2D6 gene 31 wild-type |
| | 31w | | sense 15 mer |
| 6 | CYP450 2D6- | gccatgatagtgg | CYP 2D6 gene 31 SNP sense |
| | 31m | | 13 mer |
| 7 | CYP450 2D6- | ccgccgcaactgcagag | CYP 2D6 gene 883 wild- |
| | 883w | | type 17 mer antisense |
| 8 | CYP450 2D6- | ccgcaagtgcaga | CYP 2D6 gene 883 SNP |
| | 883m | | 13 mer antisense |

For a PNA chip, an epoxy-treated glass slide is used, and PNA oligomers can be efficiently immobilized thereon with PNAArray™ spotting buffer (Panagene Inc.). In this invention, as target nucleic acids broadly scattered over genome, requiring long sized amplification, 2C19 and 2D6 genes playing the most important role in drug metabolism, among CYP 450 genes involved in various drug metabolism, are chosen and amplified to 2-5 kb (1.9 kb, 2.7 kb, and 4.4 kb).

In one embodiment of the present invention, specific signals and signal distinguishabilities for hybridization on a PNA chip are compared, according to the methods comprising:

1) amplifying target nucleic acids with primers (see the following Table 2), performing hybridization between the target nucleic acids and PNA probes on the chip, and then, attaching a detectable label only to the hybridized target nucleic acids (see right panel of FIG. 2); or

2) amplifying target nucleic acids with primers (see the following Table 2), performing hybridization between the target nucleic acids and PNA probes on the chip, while fragmenting the target nucleic acids by adding a nuclease to the hybridization solution, and then, attaching a detectable label only to the hybridized target nucleic acids (see FIG. 3);

For instance, the method of the present invention comprises the following steps:

a) preparing target nucleic acids for a PNA chip;

b) fragmenting the target nucleic acids;

c) hybridizing the target nucleic acids with PNA probes;

d) washing to remove residual reactants;

e) labeling the hybridized target nucleic acids with a detectable label;

f) washing to remove residual reactants; and

g) detecting signals from the hybridization.

In step a), any conventional nucleic acid amplification methods can be used. In this invention, no fluorescent dye is included in the amplification. Thus, there is no limitation in an amplification method that can be used. For example, branched DNA (bDNA) amplification, 3SR (self-sustained sequence replication), selective amplification of target polynucleotide sequences, hybrid capture, ligase chain reaction (LCR), polymerase chain reaction (PCR), nucleic acid sequence based amplification (NASBA), reverse transcription-PCR (RT-PCR), strand displacement amplification (SDA), transcription mediated amplification (TMA), RNA derived cDNA amplification, transcribed RNA derived cRNA amplification or rolling circle amplification (RCA) can be used. In case of amplification in the presence of a label, target nucleic acids of 2 kb or longer, show reduced amplification efficiency, and require a large amount of labeled dNTP (dATP, dCTP, dGTP, and dTTP) for amplification. According to the method of the present invention, no fluorescent dye is included in the amplification reaction, and so it has no limitation on the size of nucleic acids and enables amplification to various sized targets.

In step b), target nucleic acids are fragmented to increase hybridization efficiency. The present invention has no limitation on fragmentation methods that can be used. For example, random fragmentation of DNA can be used. For random fragmentation of amplified nucleic acids, DNaseI (Comparison of Two CYP 2D6 Genotyping Methods and assessment of genotype-Phenotype Relationship, Chou et al., 2003, clinical chemistry. 49(4) 542-551), AP endonuclease (Recognition of oxidized abasic sites by repair endonucleases. Haring et al., 1994, Nuc. Acids Res. 22:2010-2015 and US Patent Publication No. 2005-191682), and the like can be used.

In this invention, nucleic acids can be fragmented with a nuclease. The nuclease is not specially limited, and for example, DNaseI, exonuclease, endonuclease and the like can be used alone or in a mixture. Exonuclease and endonuclease are exemplified by exonuclease 1, S1 nuclease, mung bean nuclease, ribonuclease A, ribonuclease T1, nuclease P1, etc. In addition, nucleic acids are fragmented through a chemical method (In vitro detection of endonuclease IV-specific DNA damage formed by bleomycin in vivo. Levin and Demple, Nuc. Acids Res. 1996, 24:885-889 and US Patent Publication No. 2005-191682) or a physical method, e.g. sonication.

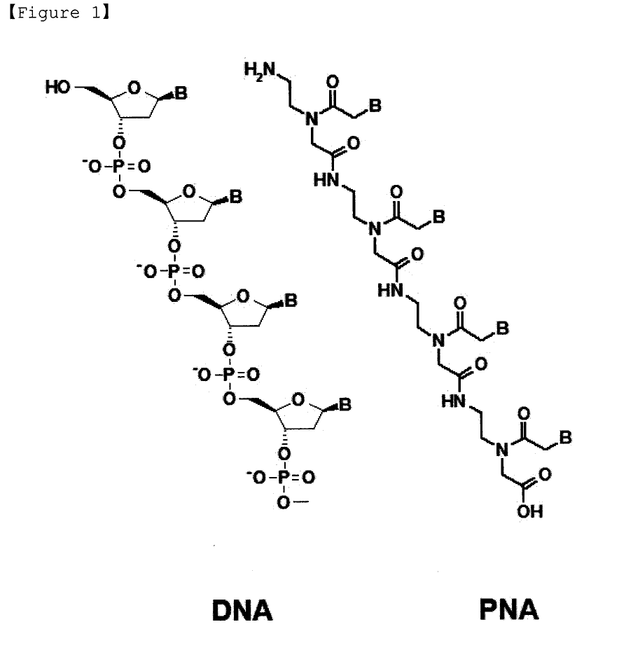

Step c) is a conventional hybridization reaction. Specifically, fragmented target nucleic acids are added in a mixture with a hybridization buffer, and the mixture is placed at an appropriate temperature to allow target nucleic acids complementary to probes to bind with the probes. A DNA chip is not preferred herein because immobilized DNA probes themselves are unstable against biological enzymes and readily degraded by nucleases. Thus, PNA, very stable against biological enzymes including nucleases may be used in this invention. As shown in FIG. 1, the high stability of PNA against biological enzymes including nucleases enables the simultaneous hybridization and fragmentation of target nucleic acids. The most conventional PNA having N-aminoethylglycine backbone can be used, but any one having a modified backbone can be used as well (P. E. Nielsen and M. Egholm “An Introduction to PNA” in P. E. Nielsen (Ed.) “Peptide Nucleic Acids: Protocols and Applications” 2nd Ed. Page 9 (Horizon Bioscience, 2004)). In addition to PNA, DNA analogues stable against nucleases can be used. For example, such modified DNAs as phosphorothioate, 2′-O-methyl, 2-O-allyl, 2-O-propyl, 2′-β-pentyl or 2′-fluoro DNAs can be used (Nuclease Resistance and Antisense Activity of Modified Oligonucleotides Targeted to Ha-ras, Monia et al., 1996, J bio, chem. 271: 14533-14540 and Characterization of fully 2′-modified oligoribonucleotide hetero- and homoduplex hybridization and nuclease sensitivity, Cummins et al., 1995, Nuc. Acids Res. 23:2019-2024).

In this step, a nuclease can be added alone or in a mixture as described in step b), thereby simultaneously performing hybridization and fragmentation of target nucleic acids to increase hybridization efficiency (that is, steps b) and c) are performed simultaneously). In particular, S1 nuclease is widely used, which is capable of degrading a single-stranded nucleic acid and a double-stranded nucleic acid having nick as well as heteroduplex DNA having loop or gap (Vogt., 1980 Methods Enzymol. 65:248-255). So, if S1 nuclease is used, PNA/DNA binding with one nucleotide mismatch is unstable, and the target is degraded by S1 nuclease, while the nuclease cannot recognize the region of PNA/DNA perfect matches to maintain a strong bond. As a result, hybridization specificity can be increased, fragmentation can be performed simultaneously with hybridization to simplify the process, and further, long targets can be fragmented to increase hybridization efficiency. In case of using DNaseI for fragmentation, target nucleic acids may have the length of 50-200 bp.

In step d), washing is performed according to a conventional process. Removal of unreacted target nucleic acids, etc. remaining after hybridization to retain only target nucleic acids complementarily bound to probes enables the efficient labeling of target nucleic acids with a reduced amount of labels and enzymes.

In step e), to detect the hybridized target nucleic acids, the target nucleic acids are labeled with a detectable label.

After hybridization, only target nucleic acids hybridized with immobilized PNA probes are labeled. For this, an enzyme, such as terminal deoxynucleotidyl transferase or ligase, is generally used to attach labels to single or double stranded nucleic acid fragments. Terminal deoxynucleotidyl transferase refers to an enzyme capable of transferring a nucleic acid to 3′ terminal of a target nucleic acid to extend it, preferably, attaching ddNTP to 3′-OH region of a nucleic acid, or dNTP or an oligonucleotide at the end of the nucleic acid fragment.

For inducing a specific signal, such a fluorescent dye as Cy5 or Cy3 is directly linked to, or such an agent as biotin that can react with a fluorescent dye is linked to dNTP (dATP, dCTP, dGTP, and dTTP), e.g. dCTP. ddNTP (ddATP, ddCTP, ddGTP, and ddTTP) can also be used, and an oligonucleotide containing a fluorescent dye can be used, as well. In addition to the enzymatic methods as described above, a chemical method can be used for labeling with a fluorescent dye. The chemical should not be reactive with PNA probes but reactive with target nucleic acids hybridized with PNA probes to selectively label the target nucleic acids. It may label a target nucleic acid within or at the end of its polynucleotide chain.

A label that can be used herein is not specially limited, and examples thereof include biotin, rhodamine, cyanine 3, cyanine 5, pyrene, cyanine 2, green fluorescent protein (GFP), calcein, fluorescein isothiocyanate (FITC), alexa 488, 6-carboxy-fluorescein (FAM), 2′,4′,5′,7′-tetrachloro-6-carboxy-4,7-dichlorofluorescein (HEX), 2′,7′-dichloro-6-carboxy-4,7-dichlorofluorescein (TET), fluorescein chlorotriazinyl, fluorescein, Oregon green, magnesium green, calcium green, 6-carboxy-4′,5′-dichloro-2′,7′-dimethoxyfluorescein (JOE), tetramethylrhodamine, tetramethyl-rhodamine isothiocyanate (TRITC), carboxytetramethyl rhodamine (TAMRA), rhodamine phalloidin, pyronin Y, lissamine, ROX (X-rhodamine), calcium crimson, Texas red, Nile red and thiadicarbocyanine.

The post-hybridization labeling to selectively label the hybridized target nucleic acid according to the present invention cannot be applied to a DNA chip. This is because probes immobilized thereon are DNAs, and the probes are also reactive with terminal deoxynucleotidyl transferase to attach fluorescent dyes thereto, making their distinction from target nucleic acids hybridized therewith difficult. For such reason, on a DNA chip, a fluorescent dye should be labeled to fragmented target nucleic acids during or after amplification.

In this case, residual dNTPs, amplification enzymes, and the like, during or after amplification, may interrupt the labeling reaction, and so they should be removed. Further, a fluorescent dye should be labeled to all the amplified and fragmented nucleic acids, indicating that a large amount of fluorescent dyes and reaction enzymes are required. In contrast, the method of the present invention involves the reduced number of steps without requiring the pre-treatment step for removing the residual reactants, saving labor and time, because only target nucleic acids hybridized with probes are labeled with a fluorescent dye after hybridization by using terminal deoxynucleotidyl transferase. In addition, the labeling can be efficiently performed with only a smaller amount of enzyme and fluorescent dye, compared with the conventional method to label a fluorescent dye to all the amplified target nucleic acids.

In step f), washing is performed according to a conventional process, to remove unreacted residual labels and enzymes.

In step g), detection of signals from hybridization can be performed by any of known methods, depending upon kinds of signal inducing agents used, which can be exemplified by fluorescence detection, electrochemical method, measurement of mass changes, measurement of electric charge changes, and measurement of optical property changes. In a specific embodiment of the present invention, biotin is used as a label and Cy5-linked streptavidin, capable of binding with biotin, is used to emit fluorescent signal.

2) Embodiment without the Fragmentation of Target Nucleic Acids

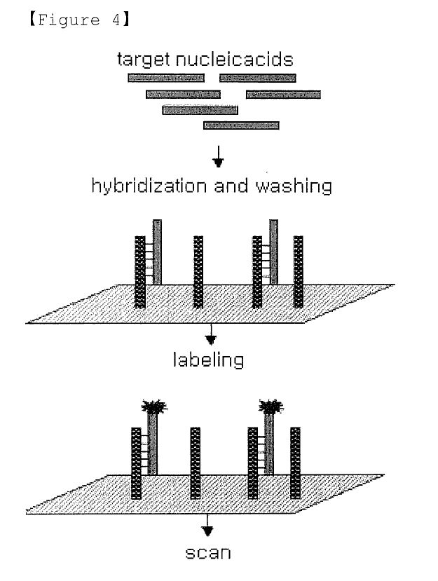

As shown in FIG. 4, in case of relatively short target nucleic acids, for example, of 400 by or less, particularly, of 10 by to less than 200 bp, the target nucleic acids are hybridized with PNA probes on a PNA chip, the chip is washed, and then, the hybridized target nucleic acids are selectively labeled and detected.

For example, the method of the present invention comprises the steps of:

a) preparing target nucleic acids for a PNA chip;

b) hybridizing the target nucleic acids with PNA probes;

c) washing to remove residual reactants after hybridization;

d) labeling the hybridized target nucleic acids with a detectable label;

e) washing to remove residual reactants; and

f) detecting signals from the label.

Steps a)-f) can be performed in substantially the same manner as described above for ‘1) Embodiments with fragmentation of target nucleic acids’, so explanations thereon are omitted herein.

In step a), the target nucleic acids can be RNA, particularly, total RNA extracted from cells, and more particularly, microRNA.

In step d), if target nucleic acids are RNAs, it is preferable to add a label linked to pCp together with T4 ligase. The method of the present invention to label hybridized target nucleic acids with a fluorescent dye after hybridization cannot be applied to a DNA chip. This is because DNA probes, immobilized on the chip, are also labeled by the enzyme, and so not only target nucleic acids hybridized with DNA probes but also DNA probes not hybridized with target nucleic acids generate signals (see FIG. 15). In step d), in a specific embodiment of the present invention, Cy3-linked pCp is used to detect fluorescent signals.

According to the method of the present invention, a fluorescent dye does not need to be added during amplification, so various amplification methods and target nucleic acids containing no fluorescent dye can be used. Further, by performing fragmentation, target nucleic acids can be used without limitation on their size. As compared with the conventional pre-hybridization labeling method, this method can selectively label only the hybridized target nucleic acids, to enable efficient and economic labeling in a simple manner with a small amount of labels and enzymes. Thus, it can be applied to any methods based on detection of nucleic acid hybridization.

Hereinafter, the present invention will be described in more detail with reference to the following examples, which are provided only for the better understanding of the invention, and should not be construed to limit the scope of invention in any manner.

### Example 1

### Synthesis of Primers for Preparation of Target Nucleic Acids

To prepare target nucleic acids of the present invention, primers for PCR were synthesized first. As shown in Table 2, three primers were selected that could amplify all the region of 2C19 and 2D6 genes among CYP 450 genes involved in drug metabolism.

The primers used for PCR were not linked with biotin, and synthesized by Bioneer (Korea).

TABLE 2

| | | | |
|---|---|---|---|
| | SEQ. | | PCR product |
| Designation | ID No | Primer sequence (5′→3′) | size (kb) |

| | | | |
|---|---|---|---|
| CYP 2C19-F | 9 | CCATTATTTAACCAGCTAGGC | 1.9 |
| (exon 4, 5) | | | |
| CYP 2C19-R | 10 | TCCTATCCTGACATCCTTATTG | |
| (exon 4, 5) | | | |
| CYP 2D6- | 11 | GGTCCCACGGAAATCTGTCTCTGT | 2.7 |
| promoter-F | | | |
| CYP 2D6- | 12 | GCCTGGACAACTTGGAAGAACC | |
| promoter-R | | | |
| CYP 2D6-coding-F | 13 | GTGTGTCCAGAGGAGCCCAT | 4.4 |
| CYP 2D6-coding-R | 14 | TGCTCAGCCTCAACGTACCCC | |

### Example 2

### Mutagenesis and Cloning for Preparing Target Nucleic Acids

Nucleic acids were amplified from human total DNA with each primer, and the amplified nucleic acids were ligated to pGEM-T easy vector (Promega, USA). E. coli JM 109 cells were transformed with the vector to produce DNA at a large amount.

The DNA was sequenced and confirmed to have no mutation, to obtain normal DNA clones.

To obtain clones having mutant genes affecting drug metabolism, mutation was induced for the normal clones obtained above by using Stratagene mutagenesis kit (Promega, USA), to obtain clones having mutant genes.

### Example 3

### Preparation of Target Nucleic Acids by PCR with Primers

The normal DNA and the mutant DNA cloned above were used as template DNA, respectively. The DNAs were amplified by PCR with each primer as shown in the above Table 2, in the following condition:

Treatment at 94° C. for 5 minutes; 35 cycles of denaturation at 94° C. for 1 minute, annealing at 62° C. for 1 minute, and extension at 72° C. for 6 minutes; followed by final extension at 72° C. for 7 minutes, in the composition of 2 μl of template DNA solution (50 ng/μl), 1 μl of each sense primer (20 μmol/μl) and 1 μl of each antisense primer (20 pmol/μl) as shown in Table 2, 3 μl of dNTP (25 mM), 5 μl of 10×Taq buffer containing MgCl₂, 5 μl of Band Doctor (Solgent Co., Ltd., Korea), 0.2 μl of Taq (5 U/μl, Solgent Co., Ltd., Korea) and 36.8 μl of distilled water.

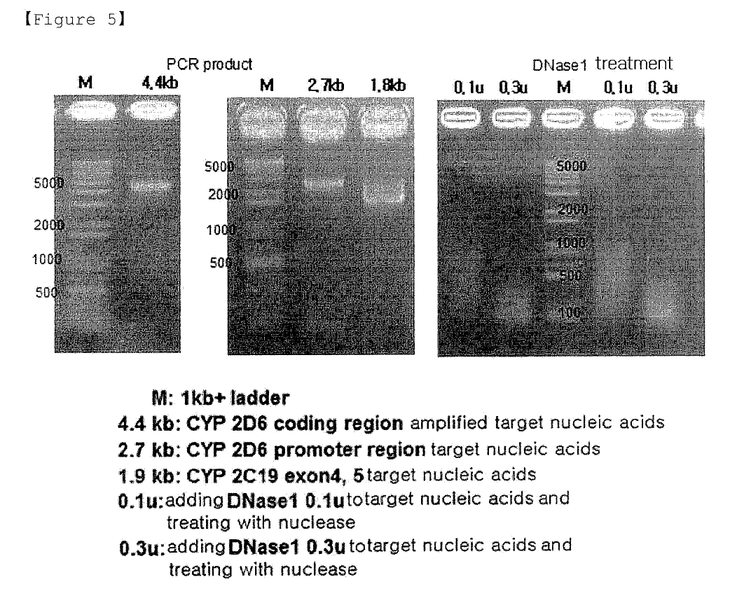

Upon completion of the reaction, to 5 U/μl of the PCR product (1.9 kb, 2.7 kb, 4.4 kb) was added 1 μl of gel loading buffer (Sunbio, Co., Ltd., Korea) followed by electrophoresis on 1.5% agarose gel. The gel was stained with 1 μg/ml of ethidium bromide (EtBr) to observe the PCR product under UV transilluminator (see left and middle panels of FIG. 5).

### Example 4

### Construction of a PNA Chip

The purified PNA oligomers represented by SEQ. ID Nos. 1 to 8, as shown in Table 1, were diluted to 50 mM in PNAArray™ spotting buffer (50 mM, Panagene, Korea), and spotted on an epoxy coated glass slide in a pin mode. It was allowed to stand at room temperature while maintaining a relative humidity of 75% for 4 hours. Then, the slide was introduced into DMF (dimethyl formamide), and washed by ultrasonication for 15 minutes. The slide was introduced into DMF containing 0.1 M succinic unhydride, followed by reaction at 40° C. for 2 hours to remove residual amine group. The slide was washed with DMF for 15 minutes, and washed by ultrasonication with deionized water for 15 minutes. 100 mM Tris-HCl containing 0.1 M ethanolamine was added thereto, followed by reaction at 40° C. for 2 hours to inactivate residual epoxy group on the solid surface. The slide was washed with deionized water for 5 minutes, and then, dried.

### Example 5

### Fragmentation of Amplified Target Nucleic Acids

To fragment the amplified product of 2-5 kb, 0.3 μl of DNaseI (1000 U/μl) was added to 10 μl of the amplified product. 0.3 μl of 20 mM EDTA and 9.4 μl of distilled water were added thereto, followed by reaction at 25° C. for 30 minutes. To inactivate the enzyme, the mixture was placed at 95° C. for 5 minutes. As a result, nucleic acid fragments of approximately 50-200 by were obtained (see FIG. 5, right panel).

### Example 6

### Hybridization of Fragmented Target Nucleic Acids

5 μl of the fragmented PCR product was added to 100 μl of PNAArray™ hybridization buffer (Panagene, Korea). 100 μl of the hybridization buffer was contacted to the PNA chip constructed in Example 4, followed by hybridization at 40° C. for 1 hour. Upon completion of the reaction, the chip was washed with PNAArray™ washing buffer (Panagene, Korea) twice at room temperature for 5 minutes, and then, dried.

### Example 7

### Simultaneous Fragmentation and Hybridization of Target Nucleic Acids

0.3 μl of DNaseI (1000 U/μl) and 0.3 μl of 20 mM EDTA were added to 10 μl of the PCR product, and 90 μl of PNAArray™ hybridization buffer (Panagene, Korea) was added thereto. 100 μl of the hybridization buffer was contacted to the PNA chip constructed in Example 4, followed by hybridization at 40° C. for 1 hour. Upon completion of the reaction, the chip was washed with PNAArray™ washing buffer (Panagene, Korea) twice at room temperature for 5 minutes, and then, dried.

### Example 8

### Post-Hybridization Labeling of Target Nucleic Acids Specifically Bound with Probes with a Fluorescent Dye

The PNA chip on which hybridization had been performed according to the methods of Examples 6 and 7 was reacted with a composition comprising 20 μl of 5× terminal deoxynucleotidyl transferase (Roche, Germany), 1 μl of 25 mM CoCl₂ solution, 1 μl of 0.01 mM 11-biotin-ddUTP, 0.01 μl of TdT (400 U/μl), and 79.9 μl of distilled water in 100 μl of reaction buffer at 37° C. for 30 minutes. Upon completion of the reaction, the chip was washed with PNAArray™ washing buffer (Panagene, Korea) twice at room temperature for 5 minutes, and then, dried.

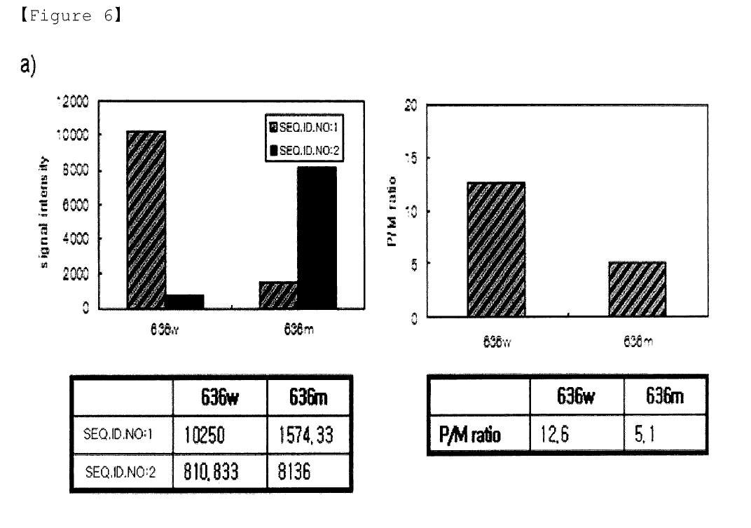

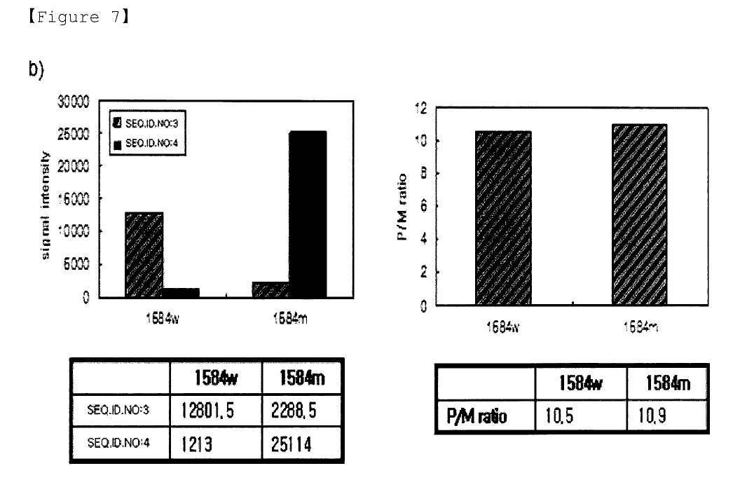

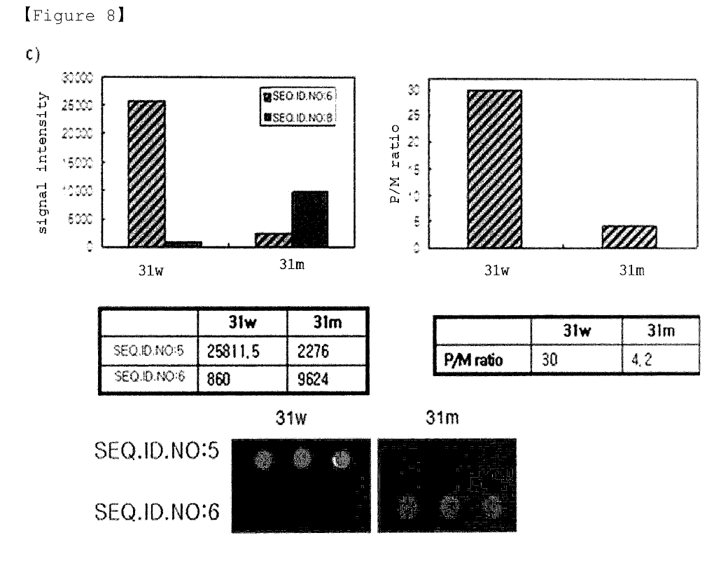

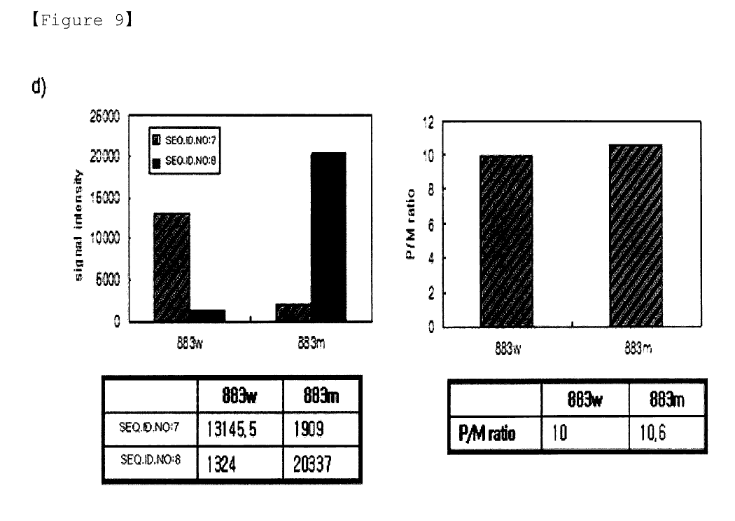

To induce fluorescent reaction on the dried PNA chip, a mixture of 100 μl of hybridization buffer and streptavidin-Cy5 was added, followed by reaction at 40° C. for 30 minutes. Upon completion of the reaction, the chip was washed with PNAArray™ washing buffer (Panagene, Korea) twice at room temperature for 5 minutes, and then, dried. Image of the PNA chip was analyzed by using a fluorescence scanner (Genepix 4000B, Exon, USA). The results are shown in FIGS. 6 to 9 and FIG. 10. As shown in FIGS. 6 to 9, as a result of labeling of target nucleic acids of 2-5 kb with a fluorescent dye, after fragmentation with DNaseI followed by hybridization on the chip, the fluorescent dye was not attached to immobilized PNA probes but to hybridized target nucleic acids to generate specific signals, distinguishable from non-specific signals.

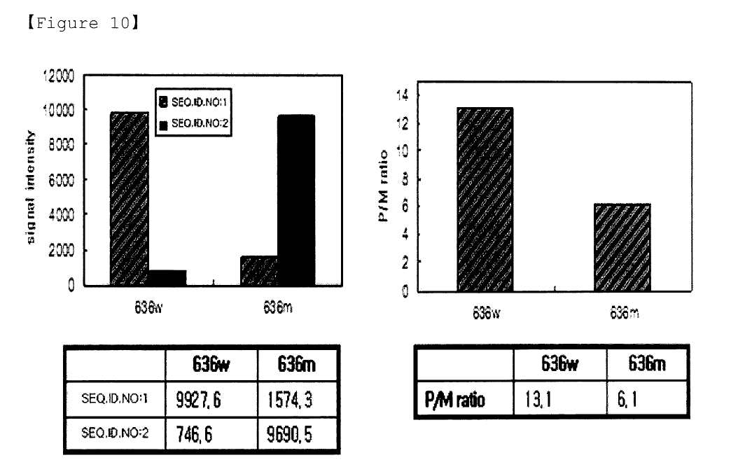

As shown in FIG. 10, as a result of labeling of the target nucleic acids with a fluorescent dye, after simultaneous fragmentation with DNaseI and hybridization on the chip, similar specific signals and S/N ratio could be obtained.

### Comparative Example 1

### Pre-Hybridization Labeling of Fragmented Target Nucleic Acids with a Fluorescent Dye

To 10 μl of the target nucleic acids, fragmented according to the method described in the literature, Chou et al. (2003) “Comparison of Two CYP 2D6 Genotyping Methods and Assessment of Genotype-Phenotype Relationship”, Clinical Chemistry 49(4) 542-551, and purified with alkaline phosphatase, was added a composition comprising 6.8 μl of 5× terminal deoxynucleotidyl transferase (Roche, Germany), 0.8 μl of 25 mM CoCl₂ solution, 0.8 μl of 1 mM 11-biotin-ddUTP, and 1.6 μl of TdT (400 U/μl), followed by reaction at 37° C. for 35 minutes. To inactivate the enzyme, the reaction was further performed at 95° C. for 5 minutes. 80 μl of PNAArray™ hybridization buffer (Panagene, Korea) was added to 20 μl of the reaction product. 100 μl of the hybridization buffer was contacted to the PNA chip constructed in Example 4, followed by hybridization at 40° C. for 1 hour. Upon completion of the reaction, the chip was washed with PNAArray™ washing buffer (Panagene, Korea) twice at room temperature for 5 minutes, and then, dried. The results are shown in FIG. 11. As shown in FIG. 11, the method of the present invention showed higher specific signals and S/N ratio, compared with the prior art method.

### Example 9

### Measurement of Fluorescence Intensity for Post-Hybridization Labeling on a PNA Chip

5.6 μl of a mixed solution of 15 synthetic RNAs having the nucleotide sequences of 15 microRNAs (miR-107, miR-103, miR-10b, miR-124a, miR-140-5p, miR-140, miR-141, miR-155, miR-17-3p, miR-199a-3p, miR-199b, miR-200a, miR-20a, miR-224, miR-372) and having no label was mixed with 100 μl of PNAArray™ hybridization buffer (Panagene, Korea), followed by hybridization on a microarray having immobilized PNA probes of nucleotide sequences complementary to those of the microRNAs at 40° C. for 2 hours. Upon completion of the reaction, the microarray was washed with PNAArray™ washing buffer (Panagene, Korea) twice at room temperature for 5 minutes, and then, dried. 10 μl of 10×T4 RNA ligase buffer, 2 μl of 0.1% bovine serum albumin (BSA), 1 μl (15 U) of T4 RNA ligase and 3 μl of Cy3-conjugated pCp (pCp-Cy3, Agilent, USA) were added to the microarray. The microarray was contacted with a solution containing RNase-free water at a final volume of 100 μl, followed by reaction at 37° C. for 2 hours. Upon completion of the reaction, the microarray was washed with PNAArray™ washing buffer (Panagene, Korea) twice at room temperature for 5 minutes, and then, dried. Fluorescence signals emitted from PNA probes immobilized on the glass slide were measured using a fluorescence scanner (GenePix 4000B, USA).

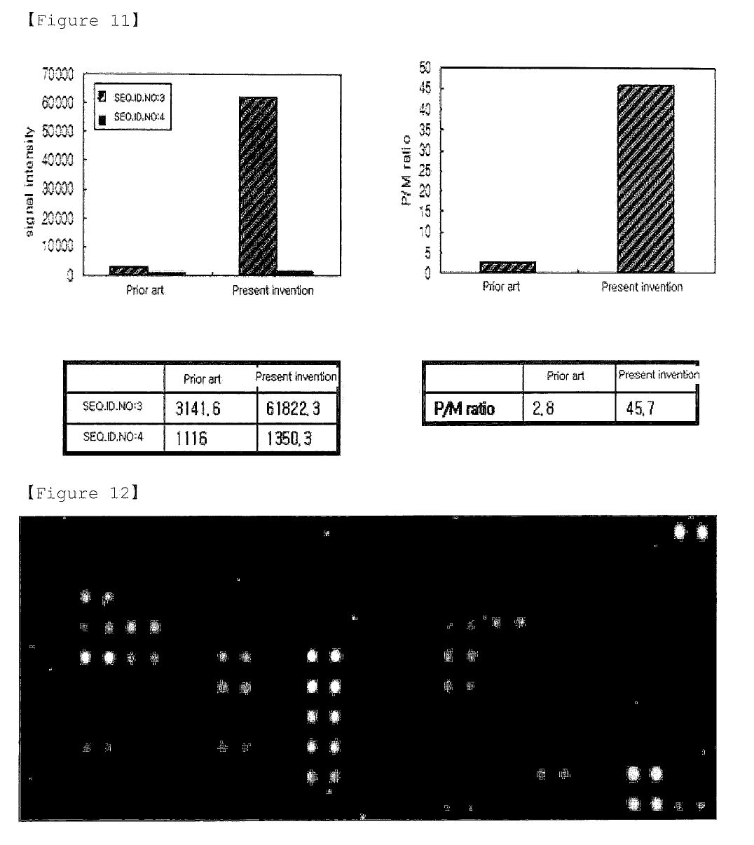

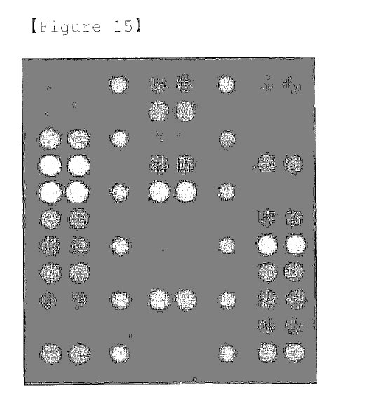

Fluorescence image (PMT gain: 700; laser output: 100%) is shown in FIG. 12 and fluorescence intensity is shown in FIG. 14.

### Comparative Example 2

### Measurement of Fluorescence Intensity for Pre-Hybridization Labeling on a PNA Chip

5.6 μl of a mixed solution of 15 synthetic RNAs having the nucleotide sequences of 15 microRNAs (miR-107, miR-103, miR-10b, miR-124a, miR-140-5p, miR-140, miR-141, miR-155, miR-17-3p, miR-199a-3p, miR-199b, miR-200a, miR-20a, miR-224, miR-372) and having no label was mixed with 0.7 μl of 10×CIP (Calf Intestinal Alkaline Phosphatase) and 0.7 μl (16 U) of CIP (Promega, USA) to make the final volume to be 7 μl, followed by reaction at 37° C. for 30 minutes. 5 μl of 100% DMSO (dimethyl sulfoxide) (Sigma, USA) was added to the reaction solution. The reaction solution was allowed to stand at 100° C. for 10 minutes. The reaction solution was cooled to room temperature, and 10 μl of 10×T4 RNA ligase buffer, 2 μl of 0.1% BSA, 1 μl (15 U) of T4 RNA ligase and 3 μl of cPc-Cy3 (Agilent, USA) were added thereto. RNase-free water was added thereto to make the final volume to be 25 μl, followed by reaction at 16° C. for 2 hours. The reaction solution was purified by using Micro-6 spin column (Bio-Rad, USA). The purified reaction solution was mixed with 75 μl of PNAArray™ hybridization buffer (Panagene, Korea). Hybridization reaction was performed on a microarray having immobilized PNA probes of sequences complementary to the microRNAs at 40° C. for 2 hours. Upon completion of the reaction, the microarray was washed with PNAArray™ washing buffer (Panagene, Korea) twice at room temperature for 5 minutes, and then, dried.

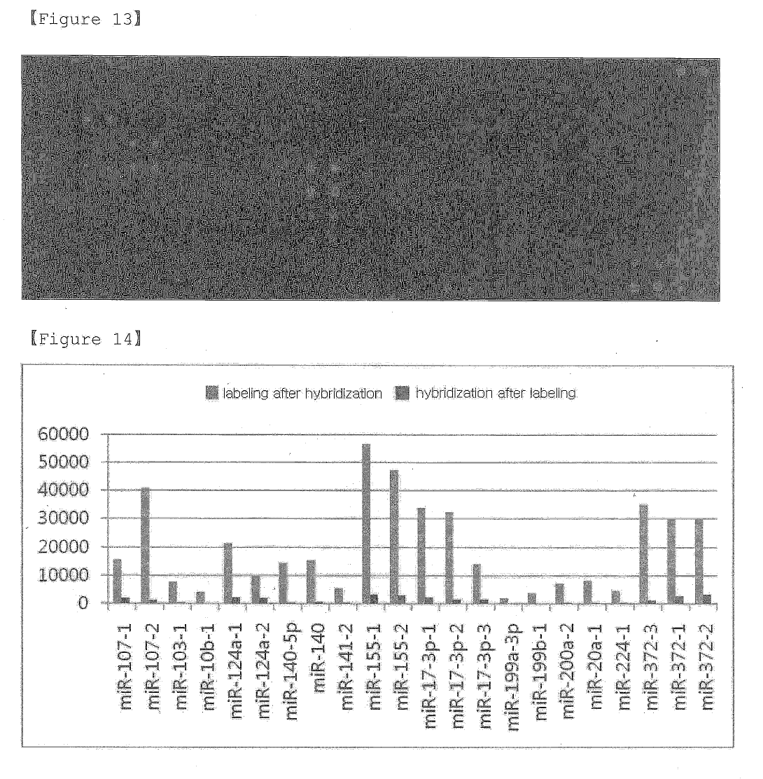

Fluorescence signals emitted from PNA probes immobilized on the glass slide were measured using a fluorescence scanner (GenePix 4000B, USA). Fluorescence image (PMT gain: 700; laser output: 100%) is shown in FIG. 13 and fluorescence intensity is shown in FIG. 14.

Example 9, post-hybridization labeling of microRNAs on a PNA chip, showed 5 to 36 fold higher fluorescence signals than Comparative Example 2, pre-hybridization labeling of microRNAs on a PNA chip.

### Comparative Example 3

### Measurement of Fluorescence Intensity for Labeling on a DNA Chip

10 μl of 10×T4 RNA ligase buffer, 2 μl of 0.1% bovine serum albumin (BSA), 1 μl (15 U) of T4 RNA ligase and 3 μl of pCp-Cy3(Agilent, USA) were added to the microarray having immobilized DNA probes on which no target nucleic acids had been hybridized. The microarray was contacted with 100 μl of a solution containing RNase-free water, followed by reaction at 37° C. for 2 hours. Upon completion of the reaction, the microarray was washed with PNAArray™ washing buffer (Panagene, Korea) twice at room temperature for 5 minutes, and then, dried. Fluorescence signals emitted from PNA probes immobilized on the glass slide were measured using a fluorescence scanner (GenePix 4000B, USA). Fluorescence image (PMT gain: 700; laser output: 100%) is shown in FIG. 15.

Fluorescence signals were generated at all the sites where DNA probes were immobilized, even in the absence of target nucleic acids. Therefore, the method of the present invention could not be applied to a DNA microarray.

### INDUSTRIAL APPLICABILITY

The method of the present invention selectively labels target nucleic acids hybridized with probes. Thus, it could detect target nucleic acids with higher sensitivity using the same amount of enzymes and labels or with the same sensitivity using a smaller amount of enzymes and labels. In addition, it does not require the labeling of target nucleic acids during amplification, and so enables the amplification of mutant genes broadly scattered in one or reduced number of long amplified sequences, and can be applied in detection of SNPs broadly scattered or mutations in human genes. For instance, it can be applied for detecting mutation, SNP, genotype, gene expression, splice-variant, or for epigenetic analysis or resequencing for target nucleic acids amplified by various methods including cDNA synthesized from RNA.

### SEQUENCE LIST TEXT

SEQ. ID No. 1 shows the nucleotide sequence of CYP 2C19 636 wild-type sense 15mer PNA probe;

SEQ. ID No. 2 shows the nucleotide sequence of CYP 2C19 636 SNP sense 13mer PPNA probe;

SEQ. ID No. 3 shows the nucleotide sequence of CYP 2D6 promoter region-1584 wild-type 15mer antisense PNA probe;

SEQ. ID No. 4 shows the nucleotide sequence of CYP 2D6 promoter region-1584 SNP 15mer antisense PNA probe;

SEQ. ID No. 5 shows the nucleotide sequence of CYP 2D6 gene 31 wild-type sense 15mer PNA probe;

SEQ. ID No. 6 shows the nucleotide sequence of CYP 2D6 gene 31 SNP sense 13mer PNA probe;

SEQ. ID No. 7 shows the nucleotide sequence of CYP 2D6 gene 883 wild-type 17mer antisense PNA probe;

SEQ. ID No. 8 shows the nucleotide sequence of CYP 2D6 gene 883 SNP 13mer antisense PNA probe;

SEQ. ID No. 9 shows the nucleotide sequence of CYP 2C19-F (exon 4,5) primer;

SEQ. ID No. 10 shows the nucleotide sequence of CYP 2C19-R (exon 4,5) primer;

SEQ. ID No. 11 shows the nucleotide sequence of CYP 2D6-promoter-F primer;

SEQ. ID No. 12 shows the nucleotide sequence of CYP 2D6-promoter-R primer;

SEQ. ID No. 13 shows the nucleotide sequence of CYP 2D6-coding-F primer;

SEQ. ID No. 14 shows the nucleotide sequence of CYP 2D6-coding-R primer.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1. A method for selective labeling of target nucleic acids on an array having nucleic acid analogue probes immobilized on a support or supports, comprising:
adding to the array a detectable label and an agent for introducing the label into unlabeled target nucleic acids, after hybridization of the unlabeled target nucleic acids with the nucleic acid analogue probes, wherein the nucleic acid analogue probes are not reactive with the agent, so that only the target nucleic acids hybridized with the nucleic acid analogue probes are selectively labeled.

2. The method of claim 1, wherein the nucleic acid analogue is PNA (peptide nucleic acid).

3. The method of claim 1, wherein the agent for introducing the detectable label into the target nucleic acids is an enzyme for introducing the detectable label at the end of nucleic acids or a chemical for introducing the detectable label within or at the end of nucleic acids.

4. The method of claim 3, wherein the enzyme for introducing the detectable label at the end of nucleic acids is terminal deoxynucleotidyl transferase or ligase.

5. The method of claim 4, wherein the ligase is T4 RNA ligase.

6. The method of claim 4, wherein the detectable label is linked to ddNTP, dNTP or oligonucleotide.

7. The method according to claim 1, wherein the target nucleic acids are amplified by a method selected from the group consisting of branched DNA (bDNA) amplification, 3SR (self-sustained sequence replication), selective amplification of target polynucleotide sequences, hybrid capture, ligase chain reaction (LCR), polymerase chain reaction (PCR), nucleic acid sequence based amplification (NASBA), reverse transcription-PCR (RT-PCR), strand displacement amplification (SDA), transcription mediated amplification (TMA), RNA derived cDNA amplification, transcribed RNA derived cRNA amplification and rolling circle amplification (RCA).

8. The method of claim 1, wherein the target nucleic acids are fragmented.

9. The method of claim 8, wherein the target nucleic acids are fragmented before or during hybridization.

10. The method of claim 8, wherein the target nucleic acids are fragmented by addition of nuclease.

11. The method of claim 10, wherein the nuclease is selected from the group consisting of DNaseI, exonuclease, endonuclease and a mixture thereof.

12. The method of claim 8, wherein the target nucleic acids are fragmented by sonication.

13. The method of claim 1, wherein the target nucleic acids are RNAs.

14. The method of claim 13, wherein the target nucleic acids are microRNAs.

15. The method of claim 1, wherein the detectable label is selected from the group consisting of biotin, rhodamine, cyanine 3, cyanine 5, pyrene, cyanine 2, green fluorescent protein (GFP), calcein, fluorescein isothiocyanate (FITC), alexa 488, 6-carboxy-fluorescein (FAM), 2′,4′,5′,7′-tetrachloro-6-carboxy-4,7-dichlorofluorescein (HEX), 2′,7′-dichloro-6-carboxy-4,7-dichlorofluorescein (TET), fluorescein chlorotriazinyl), fluorescein, Oregon green, magnesium green, calcium green, 6-carboxy-4′,5′-dichloro-2′,7′-dimethoxyfluorescein (JOE), tetramethylrhodamine, tetramethyl-rhodamine isothiocyanate (TRITC), carboxytetramethyl rhodamine (TAMRA), rhodamine phalloidin, pyronin Y, lissamine, ROX (X-rhodamine), calcium crimson, Texas red, Nile red and thiadicarbocyanine.

16. A method for detection of target nucleic acids on an array having nucleic acid analogue probes immobilized on a support or supports, comprising:
1) selectively labeling the target nucleic acids according to the method of claims 1; and
2) detecting signals from the label of step 1).

17. A kit for use in the method for selective labeling of target nucleic acids on an array having nucleic acid analogue probes immobilized on a support or supports according to claim 1, comprising:
1) a detectable label enabling the detection of target nucleic acids hybridized with the nucleic acid analogue probes; and
2) an agent for introducing the detectable label not into the nucleic acid analogue probes but into the target nucleic acids hybridized with the nucleic acid analogue probes.

18. A kit for use in the method for detecting target nucleic acids on an array having nucleic acid analogue probes immobilized on a support or supports according to claim 16, comprising:
1) a detectable label enabling the detection of target nucleic acids hybridized with the nucleic acid analogue probes; and
2) an agent for introducing the detectable label not into the nucleic acid analogue probes but into the target nucleic acids hybridized with the nucleic acid analogue probes.

19. A method for detection of target nucleic acids on an array having nucleic acid analogue probes immobilized on a support or supports, comprising:
1) selectively labeling the target nucleic acids according to the method of claims 3; and
2) detecting signals from the label of step 1).

20. A kit for use in the method for selective labeling of target nucleic acids on an array having nucleic acid analogue probes immobilized on a support or supports according to claim 3, comprising:
1) a detectable label enabling the detection of target nucleic acids hybridized with the nucleic acid analogue probes; and
2) an agent for introducing the detectable label not into the nucleic acid analogue probes but into the target nucleic acids hybridized with the nucleic acid analogue probes.
